(19) United States
(12) Patent Application Publication
(10) Pub. No.: US 2022/0392164 A1
(43) Pub. Date: Dec. 8, 2022

(54) NON-TRANSITORY COMPUTER-READABLE RECORDING MEDIUM, FEATURE VALUE CALCULATION METHOD, AND INFORMATION PROCESSING APPARATUS

(71) Applicant: FUJITSU LIMITED, Kawasaki-shi (JP)

(72) Inventors: Yuichi Ike, Kawasaki (JP); Yasuhiko Asao, Wako (JP)

(73) Assignee: FUJITSU LIMITED, Kawasaki-shi (JP)

(21) Appl. No.: 17/826,247

(22) Filed: May 27, 2022

(30) Foreign Application Priority Data
Jun. 4, 2021 (JP) 2021-094241

(51) Int. Cl. G06T 17/20; G06F 17/16

(52) U.S. Cl. CPC G06T 17/20; G06F 17/16

(57) ABSTRACT

A non-transitory computer-readable recording medium stores therein a feature value calculation program that causes a computer to execute a process. The process includes calculating, for each of points included in point group data, an eigenvector by using principal component analysis on point group data that is located within a predetermined distance from each of the points; calculating a curvature of a multivariable function in which a point located closest to the calculated eigenvector is used an extreme value point; and generating a feature value of the point group data on the basis of the curvature at each of the points in the point group data.

### CROSS-REFERENCE TO RELATED APPLICATION

This application is based upon and claims the benefit of priority of the prior Japanese Patent Application No. 2021-094241, filed on Jun. 4, 2021, the entire contents of which are incorporated herein by reference.

### FIELD

The embodiments discussed herein are related to a feature value calculation program, a feature value calculation method, and an information processing apparatus.

### BACKGROUND

In various fields, in many cases, data to be analyzed is represented as a set of several real numbers, and the data is recognized as a point cloud in an n-dimensional space. In recent years, feature values are extracted or classified from pieces of point group data as described above. For example, topological data analysis (TDA) for extracting a topological feature value of point group data is known. TDA is a technique for examining a feature value, such as the number of connected components or holes, presuming a union of spheres centered at data points, and observing a topological change with an increase in radii.
Patent Literature 1: Japanese Laid-open Patent Publication No. 2019-016193

### SUMMARY

According to an aspect of an embodiment, a non-transitory computer-readable recording medium stores therein a feature value calculation program that causes a computer to execute a process. The process includes: calculating, for each of points included in point group data, an eigenvector by using principal component analysis on point group data that is located within a predetermined distance from each of the points; calculating a curvature of a multivariable function in which a point located closest to the calculated eigenvector is used an extreme value point; and generating a feature value of the point group data on the basis of the curvature at each of the points in the point group data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an information processing apparatus according to a first embodiment;

FIG. 2 is a diagram for explaining a task in TDA;

FIG. 3 is a functional block diagram illustrating a functional configuration of the information processing apparatus according to the first embodiment;

FIG. 4 is a diagram for explaining a method of calculating an eigenvector for each of points in point group data;

FIG. 5 is a diagram for explaining an extraction result of a feature value of each piece of point group data;

FIG. 6 is a flowchart illustrating the flow of a process according to the first embodiment;

FIG. 7 is a functional block diagram illustrating a functional configuration of an information processing apparatus according to a second embodiment;

FIG. 8 is a diagram for explaining a clustering result according to the second embodiment;

FIG. 9 is a flowchart illustrating the flow of a process according to the second embodiment; and

FIG. 10 is a diagram for explaining a hardware configuration example.

### DESCRIPTION OF EMBODIMENT

However, in the technology as described above, it is difficult to distinguish between pieces of point group data that are determined as having topologically the same shapes, so that accuracy in extracting feature values is reduced. For example, only the same feature values are extracted from pieces of point group data that have the same number of connected components or holes, so that it is difficult to distinguish between a flat surface and a curved surface.

Preferred embodiments will be explained with reference to accompanying drawings. The present invention is not limited by the embodiments below. In addition, the embodiments may be appropriately combined as long as no contradiction is derived.

### [a] First Embodiment

Overall Configuration

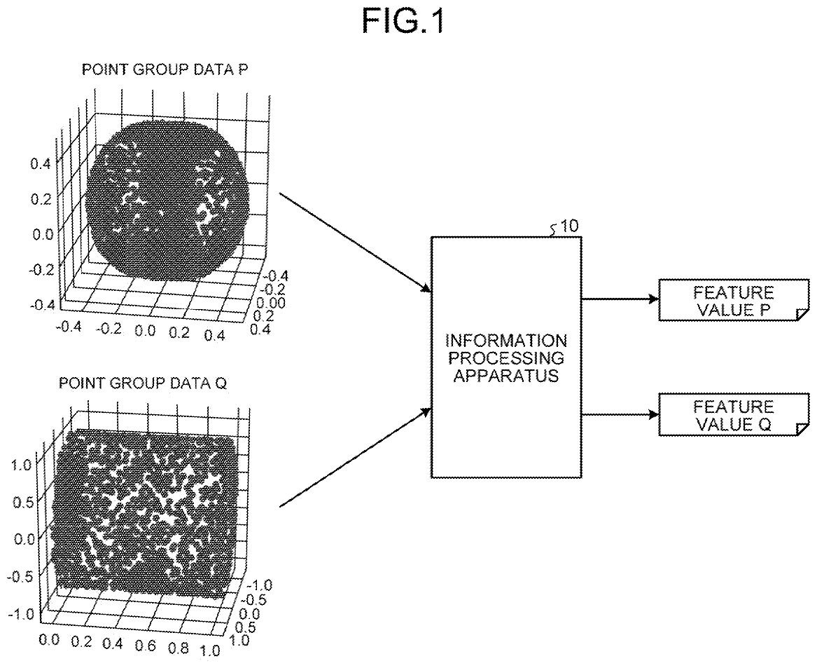

FIG. 1 is a diagram for explaining an information processing apparatus 10 according to a first embodiment. The information processing apparatus 10 is one example of a computer apparatus that generates feature values, such as a feature value P and a feature value Q, which accurately represent features of various kinds of point group data, such as point group data P and point group data Q.

Topological data analysis (TDA) that is used to generate a feature value of point group data is described below. In TDA, persistent homology transform is performed on point group data to generate a persistent diagram that characterizes a change in an m-dimensional hole, and a feature value of the point group data is generated.

Here, “homology” is a method of representing a feature of an object by the number of m-dimensional holes (m≥0). The “holes” described herein are origins of homology groups, where a zero-dimensional hole is a connected component, a one-dimensional hole is a hole (tunnel), and a two-dimensional hole is a hollow. The number of each-dimensional holes is called as the Betti number. Further, “persistent homology” is a method of characterizing a change in an m-dimensional hole in an object (in this example, a group of points (point cloud)), and, by persistent homology, it is possible to examine a feature related to arrangement of the points. In this method, each of the points in the object is gradually expanded into a spherical shape, and a time at which each of holes appears during the process (the time is represented by a radius of the sphere at the time the hole appears) and a time at which the hole disappears (the time is represented by a radius of the sphere at the time the hole disappears) are identified.

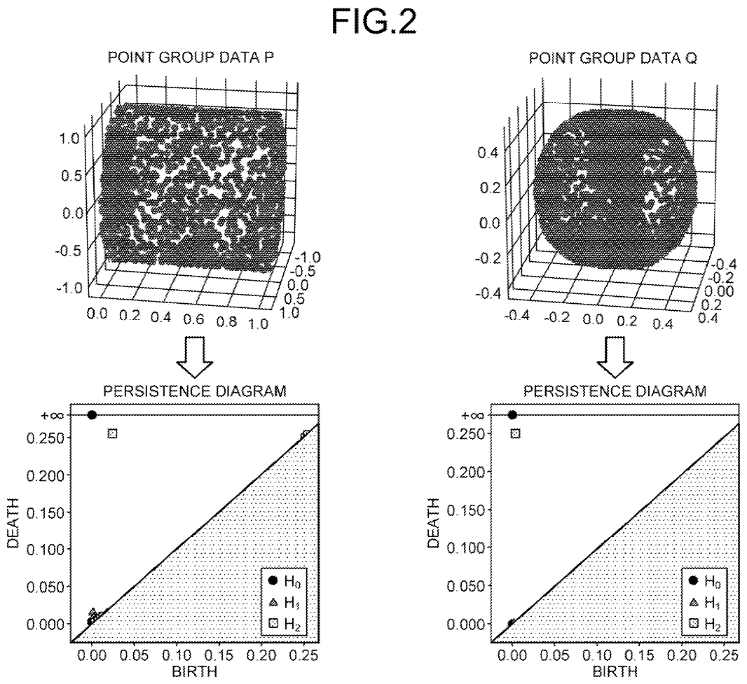

A result of generation of a feature value of each of the point group data P having a cylindrical shape and the point group data Q having a spherical shape by using the TDA will be described below. FIG. 2 is a diagram for explaining a task in TDA.

Specifically, FIG. 2 illustrates a persistence diagram that represents a timing H₀ at which a zero-dimensional hole appears (birth) and disappears (death), a timing H₁ at which a one-dimensional hole appears and disappears, and a timing H₂ at which a two-dimensional hole appears and disappears through TDA performed on the point group data P. Similarly, FIG. 2 illustrates another persistence diagram that represents a timing H₀ at which a zero-dimensional hole appears and disappears, a timing H₁ at which a one-dimensional hole appears and disappears, and a timing H₂ at which a two-dimensional hole appears and disappears through TDA performed on the point group data Q.

As can be seen from comparison between the persistence diagrams in FIG. 2, by feature value generation (analysis) using TDA, similar feature values are generated from the pieces of point group data that have topologically the same shapes, and it is difficult to distinguish between the pieces of point group data. In other words, if pieces of point group data whose shapes are unclear are analyzed, the same feature values may be generated for pieces of data having different shapes. Therefore, for example, if labeled training data is to be generated by using point group data, the same label may be assigned to pieces of point group data to which different labels need to be assigned, which leads to degradation in training accuracy.

Further, it may be possible to select a polygon by using a feature value obtained through TDA and perform fitting to point group data, but if the feature value as a selected material is not accurate, it is difficult to select an appropriate polygon. In the case illustrated in FIG. 2, the same polygon is selected for both of the point group data P and the point group data Q, so that it is difficult to accurately perform fitting.

To cope with this, the information processing apparatus 10 according to the first embodiment calculates an eigenvector for each of points included in point group data, by using principal component analysis on point group data that is present within a predetermined distance from each of the points. The information processing apparatus 10 calculates a curvature of a multivariable function in which a point located closest to the calculated eigenvector is adopted as an extreme value point (or a stationary point). The information processing apparatus 10 generates a feature value of the point group data on the basis of the curvature at each of the points in the point group data.

In other words, the information processing apparatus 10 calculates a curvature-related amount (an amount indicating a degree of bend) that is locally determined from the point group data, and adopts a frequency distribution of a value of the curvature-related amount as the feature value. As a result, the information processing apparatus 10 is able to distinguish between pieces of point group data that have topologically the same shapes but that have different shapes in relation to curvatures, so that it is possible to extract an accurate feature value of the point group data.

Functional Configuration

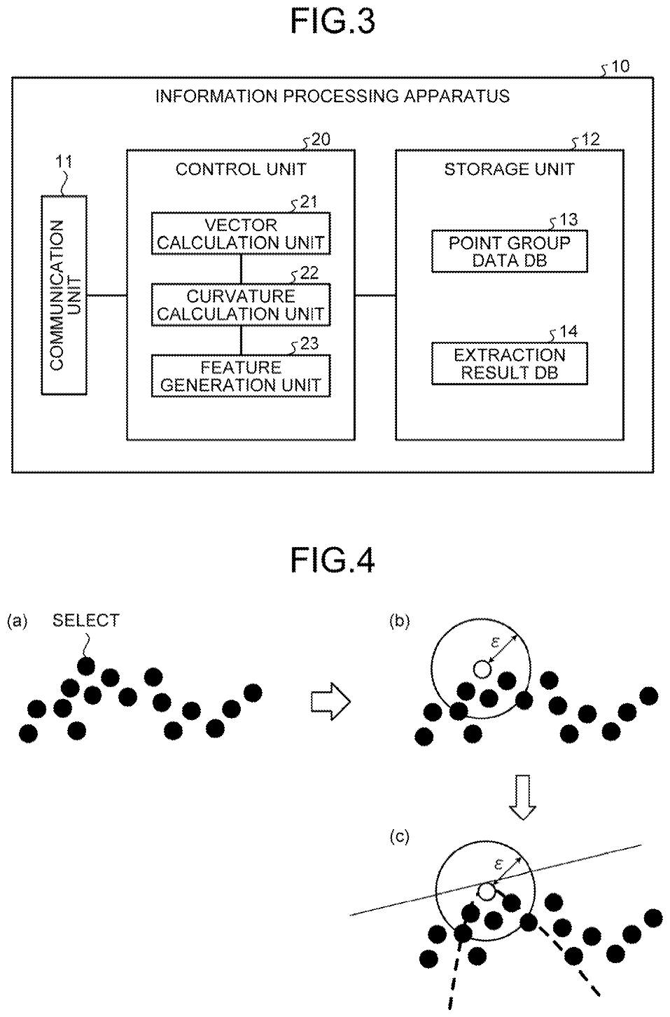

FIG. 3 is a functional block diagram illustrating a functional configuration of the information processing apparatus 10 according to the first embodiment. As illustrated in FIG. 3, the information processing apparatus 10 includes a communication unit 11, a storage unit 12, and a control unit 20.

The communication unit 11 is a processing unit that controls communication with other apparatuses, and is implemented by, for example, a communication interface or the like. For example, the communication unit 11 receives point group data from an administrator terminal, a three-dimensional (3D) sensor, or the like, and transmits an extraction result (analysis result) or the like to the administrator terminal.

The storage unit 12 is one example of a storage device that stores therein various kinds of data, a program executed by the control unit 20, and the like. For example, the storage unit 12 stores therein a point group data database (DB) 13 and an extraction result DB 14.

The point group data DB 13 is a database that stores therein pieces of point group data of various objects that are scanned in a three-dimensional space by using a 3D sensor, a range sensor, or the like, for example. In the example as described above, the point group data DB 13 stores therein the point group data P and the point group data Q. For the sake of explanation, the point group data P has a cylindrical shape and the point group data Q has a spherical shape, but the shapes are unknown until the shapes are characterized by the control unit 20.

The extraction result DB 14 is a database that stores therein an extraction result obtained by the control unit 20. For example, the extraction result DB 14 stores therein the feature value of the point group data P and the feature value of the point group data Q.

The control unit 20 is a processing unit that controls the entire information processing apparatus 10 and is implemented by, for example, a processor or the like. The control unit 20 includes a vector calculation unit 21, a curvature calculation unit 22, and a feature generation unit 23. The vector calculation unit 21, the curvature calculation unit 22, and the feature generation unit 23 may be implemented as electronic circuits included in a processor or may be implemented as processes performed by a processor.

The vector calculation unit 21 is a processing unit that calculates an eigenvector for each of points included in point group data, by using principal component analysis on point group data that is present within a predetermined distance from each of the points. For example, the vector calculation unit 21 calculates an eigenvector for each of points in the point group data P and each of points in the point group data Q.

FIG. 4 is a diagram for explaining a method of calculating an eigenvector for each of points in point group data. First, the vector calculation unit 21 receives an input or the like from an administrator or the like, and sets a threshold ε and a threshold δ that are values larger than zero with respect to point group data X that is a subset in a d-dimensional real coordinate space R^{d}.

Subsequently, as illustrated in FIG. 4(a), the vector calculation unit 21 selects a point x that is an element of the point group data X. Then, as illustrated in FIG. 4(b), the vector calculation unit 21 defines, as represented by Expression (1), a point cloud B that is included in a sphere with a radius ε centered at the point x. Subsequently, as illustrated in FIG. 4(c), the vector calculation unit 21 applies principal component analysis (PCA) to the point cloud B and acquires a space spanned by eigenvectors for which eigenvalues are equal to or larger than the threshold δ. The vector calculation unit 21 performs the process as described above for each of the points in the point group data.

B:=X∩B(x;ε) (1)

The curvature calculation unit 22 is a processing unit that calculates a curvature of a multivariable function in which a point located closest to the calculated eigenvector is adopted as an extreme value point. Specifically, the curvature calculation unit 22 calculates a curvature for each of the points in the point group data P and each of the points in the point group data Q, and outputs the curvatures to the feature generation unit 23.

For example, the curvature calculation unit 22 applies a quadratic function, which has a vertex at the point x in the above-described space in which values are present in eigenvector directions corresponding to eigenvalues that are equal to or larger than the predetermined value among the eigenvalues calculated by the vector calculation unit 21, to the point cloud B by the least squares method.

Specifically, the curvature calculation unit 22 sets coordinates x₁, x₂, . . . xₖ in a k-dimensional space in which eigenvalues are equal to or larger than the predetermined threshold δ, and sets an axis xₖ₊₁ in a direction of a k+1-th eigenvector. Subsequently, the curvature calculation unit 22 generates the quadratic function that is applied by the least squares method and that is represented by Expression (2), and calculates Hessian represented by Expression (3) with respect to the quadratic function. Then, the curvature calculation unit 22 determines Hessian as the curvature at each of the points.

$${x}_{k + 1} = f ( {x}_{1} , … , {x}_{k} ) = \frac{1}{2} {\sum }_{i , j} {a}_{ij} {x}_{i} {x}_{j} ( {a}_{ij} = {a}_{ji} ) \qquad ( 2 )$$

$$\begin{matrix}{H}_{f} = det [ \begin{matrix}{\partial }^{2} f / \partial {x}_{1} \partial {x}_{1} & ⋯ & {\partial }^{2} f / \partial {x}_{1} \partial {x}_{k} \\ ⋮ & ⋱ & ⋮ \\ {\partial }^{2} f / \partial {x}_{k} \partial {x}_{1} & ⋯ & {\partial }^{2} f / \partial {x}_{k} \partial {x}_{k}\end{matrix} ] \\ = det [ \begin{matrix}{a}_{11} & ⋯ & {a}_{1 k} \\ ⋮ & ⋱ & ⋮ \\ {a}_{k 1} & ⋯ & {a}_{kk}\end{matrix} ]\end{matrix} \qquad ( 3 )$$

The feature generation unit 23 is a processing unit that generates a feature value of the point group data on the basis of the curvature at each of the points in the point group data. Specifically, the feature generation unit 23 calculates, for each of the point group data P and the point group data Q, a distribution of the curvatures (frequency distribution) at the plurality of points in each piece of the point group data, as a feature of each piece of the point group data represented by the plurality of points, and stores the distributions in the extraction result DB 14.

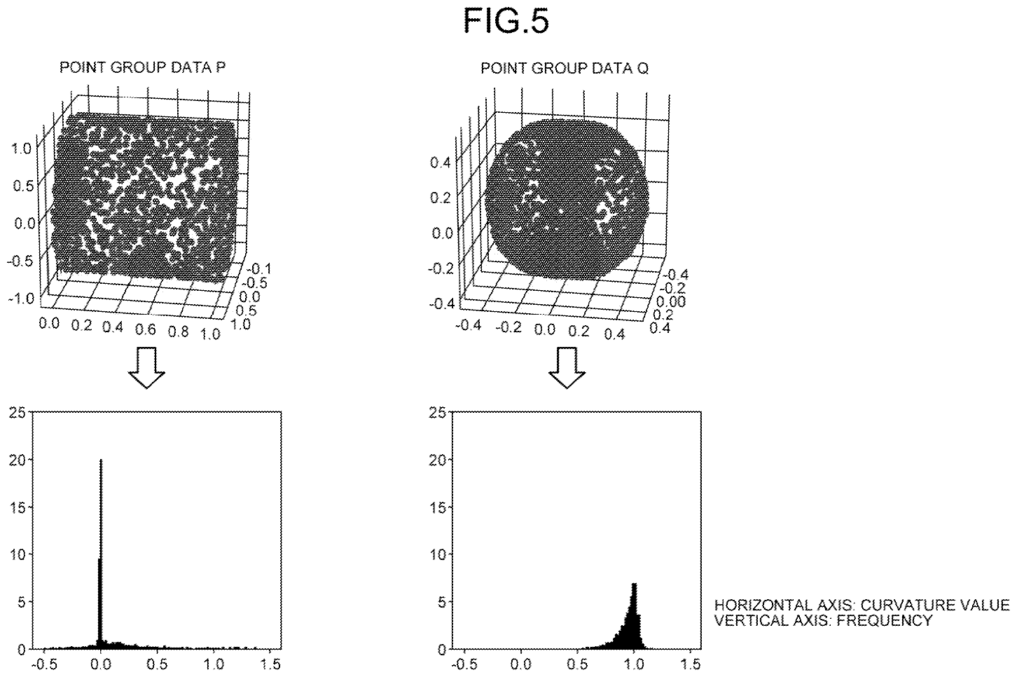

FIG. 5 is a diagram for explaining an extraction result of the feature value of each piece of the point group data. As illustrated in FIG. 5, the feature generation unit 23 generates a frequency distribution in which a horizontal axis represents a value of the curvature and a vertical axis represents a frequency (the number of points that have curvatures). In other words, the feature generation unit 23 aggregates the numbers of curvatures at all of the points in the point group data. As a result, the feature generation unit 23 is able to characterize a feature of the point group data P such that the points with the curvatures of 0.0 are concentrated and the point group data P has a certain shape with a relatively small number of curved surfaces (curves). In contrast, the feature generation unit 23 is able to characterize a feature of the point group data Q such that points with curvatures of around 1.0 are concentrated and the point group data Q has a certain shape with a relatively large number of curved surfaces (curves).

Flow of Process

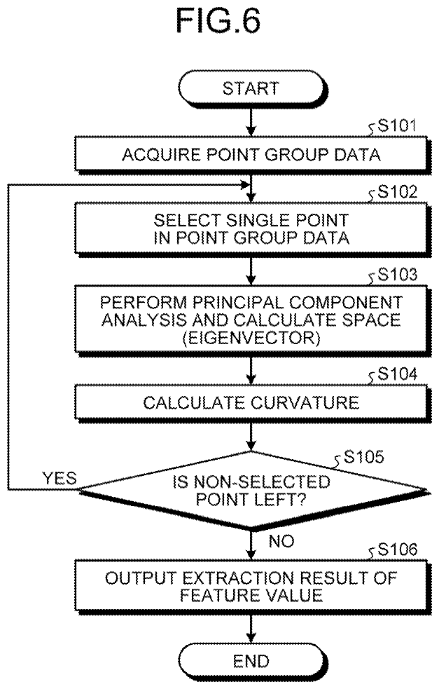

FIG. 6 is a flowchart illustrating the flow of a process according to the first embodiment. As illustrated in FIG. 6, the vector calculation unit 21 of the information processing apparatus 10 acquires point group data (S101), and selects a single point (data) in the point group data (S102).

Subsequently, the vector calculation unit 21 performs principal component analysis and calculates a space (eigenvectors) (S103). Then, the curvature calculation unit 22 calculates a curvature that is a curvature-related amount that is locally defined from the point group data (S104).

Here, if a non-selected point (data) is left in the point group data (S105: Yes), processes from Step S102 are repeated on the non-selected point. In contrast, if a non-selected point (data) is not left in the point group data (S105: No), the feature generation unit 23 generates and outputs an extraction result of the feature value of the point group data by using the calculated curvature at each of the points (S106).

Effects

As described above, the information processing apparatus 10 is able to calculate a curvature for each of points in point group data, and generate a feature value by using the curvatures. Therefore, the information processing apparatus 10 is able to focus on a local difference in relation to curvatures, and distinguish between point clouds that have topologically the same shapes but that have different shapes in relation to curvatures. Further, the information processing apparatus 10 generates a frequency distribution of the curvatures at all of the points, so that it is possible to visualize the feature value and improve interpretation performance of a user.

Furthermore, the information processing apparatus 10 is able to accurately distinguish between pieces of point group data when generating training data for a machine learning model from the point group data, so that it is possible to assign an accurate label (teacher information) to each piece of the point group data. Therefore, the information processing apparatus 10 is able to improve training accuracy of the machine learning model.

### [b] Second Embodiment

The information processing apparatus 10 is able to execute clustering of point group data by using the feature value described in the first embodiment. Therefore, in a second embodiment, an example will be described in which clustering of point group data is executed and fitting between the point group data and a polygon is accurately performed.

Functional Configuration

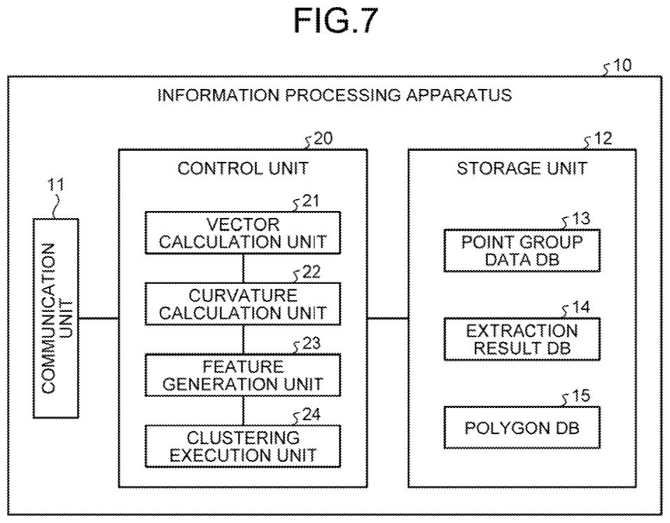

FIG. 7 is a functional block diagram illustrating a functional configuration of the information processing apparatus 10 according to the second embodiment. As illustrated in FIG. 7, similarly to the first embodiment, the information processing apparatus 10 includes the communication unit 11, the storage unit 12, and the control unit 20. The second embodiment is different from the first embodiment in that a polygon DB 15 and a clustering execution unit 24 are provided; therefore, the polygon DB 15 and the clustering execution unit 24 will be described below.

The polygon DB 15 is a databased that stores therein a plurality of polygons that are fitting targets. For example, the polygon DB 15 stores therein a plurality of polygons having different shapes and a plurality of polygons having similar shapes.

The clustering execution unit 24 is a processing unit that executes clustering of a plurality of points in point group data and outputs an execution result of the clustering, on the basis of curvatures at the plurality of points in the point group data. Specifically, the clustering execution unit 24 executes clustering of point group data in an n-dimensional space on the basis of a geometrical feature. With this configuration, when performing fitting of a mesh shape to a point cloud (point group data) that is scanned in a three-dimensional space, it is possible to extract a set of singular points, such as corners, for example.

For example, the clustering execution unit 24 receives an input or the like from an administrator or the like, and sets a scale parameter t and a threshold d. Subsequently, the clustering execution unit 24 calculates a curvature c(x) of point group data that is dependent on the threshold for each of points x (elements of X) of point group data X that is a subset in an n-dimensional real coordinate space Rⁿ. In this example, the clustering execution unit 24 calculates the curvature c(x) by using the method described in the first embodiment.

Subsequently, the clustering execution unit 24 determines that a(x)=−t if c(x)<−d, determines that a(x)=0 if |c(x)|≤d, and determines that a(x)=t if c(x)>d. Then, the clustering execution unit 24 increases the number of dimensions of the point group data X by one by using the value of the curvature, and presumes a subset in an n+1-dimensional real coordinate space Rⁿ⁺¹. Thereafter, the clustering execution unit 24 embeds each of the points of the point group data for which the number of dimensions is increased by one into the real coordinate space Rⁿ⁺¹ by Expression (4). In other words, the clustering execution unit 24 maps each of the points of the point group data for which the number of dimensions is increased by one into the real coordinate space Rⁿ⁺¹ by homeomorphism.

x [symbol] (x,a(x)) (4)

Thereafter, the clustering execution unit 24 executes clustering on a mapped image by the nearest neighbor method, executes clustering of each of the points in the point group data, and assigns a generated cluster to the point cloud that is present before embedding. In other words, the clustering execution unit 24 represents each of the points, for which the number of dimensions is increased by one, with the original dimensions.

In this manner, the clustering execution unit 24 increases the number of dimensions by one by adding a curvature to the number of dimensions at each of the points in the point group data, and executes clustering in a state in which the number of dimensions is increased by one, so that it is possible to accurately execute clustering of each of the points in the point group data and distinguish between pieces of similar point group data.

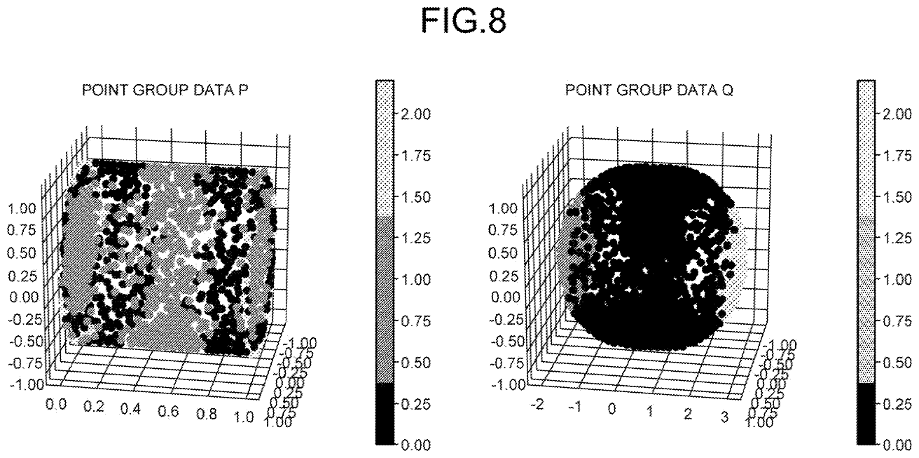

FIG. 8 is a diagram for explaining a clustering result according to the second embodiment. The clustering execution unit 24 is able to execute clustering of each of the points in the point group data, so that it is possible to perform classification into a cluster A that is a cluster of points with curvatures that are smaller than a first threshold and that are almost zero, into a cluster B that is a cluster of points with curvatures that are equal to or larger than the first threshold and smaller than a second threshold and that are slight, and into a cluster C that is a cluster of points with curvatures that are equal to or larger than the second threshold and that are large.

As a result, as illustrated in FIG. 8, the clustering execution unit 24 is able to determine even topologically similar shapes as totally different shapes as can be seen from comparison between the clustering result of the point group data P and the clustering result of the point group data Q.

Therefore, the clustering execution unit 24 is able to select a cylindrical polygon to perform fitting to the point group data P, and select a spherical polygon to perform fitting to the point group data Q. Consequently, the clustering execution unit 24 is able to select appropriate polygons and separately perform fitting from the beginning, so that it is possible to reduce an error in selection of polygons and reduce a processing time.

Flow of Process

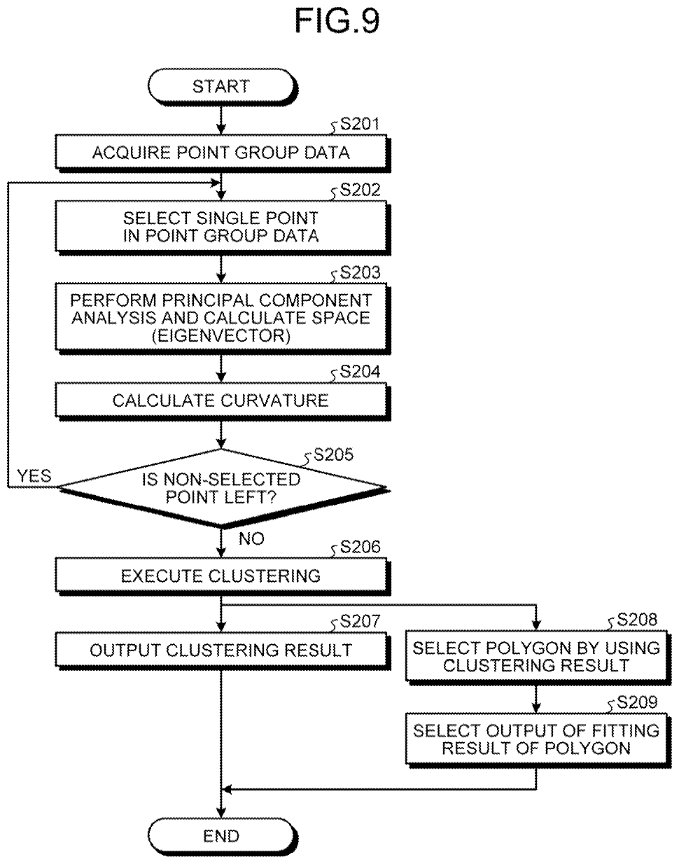

FIG. 9 is a flowchart illustrating the flow of a process according to the second embodiment. As illustrated in FIG. 9, the vector calculation unit 21 of the information processing apparatus 10 acquires point group data (S201), and selects a single point in the point group data (S202).

Subsequently, the vector calculation unit 21 performs principal component analysis and calculates a space (eigenvectors) (S203). Then, the curvature calculation unit 22 calculates a curvature that is a curvature-related amount that is locally defined from the point group data (S204).

Here, if a non-selected point (data) is left in the point group data (S205: Yes), processes from S202 are repeated on the non-selected point. In contrast, if a non-selected point (data) is not left in the point group data (S205: No), the clustering execution unit 24 executes clustering of each of the points by using the calculated curvature at each of the points in the point group data (S206).

Thereafter, the clustering execution unit 24 outputs a clustering result (S207). For example, the clustering execution unit 24 stores the clustering result in the storage unit 12 or transmits the clustering result to a destination designated by an administrator or the like.

Simultaneously, the clustering execution unit 24 selects an appropriate polygon from the polygon DB 15 by using the clustering result (S208), performs fitting of the selected polygon to the point group data, and outputs a fitting result (S209). For example, the clustering execution unit 24 stores the fitting result in the storage unit 12 or transmits the fitting result to a destination designated by an administrator or the like.

### Effects

As described above, the information processing apparatus 10 is able to calculate a curvature that is locally determined from the point group data, constructs point group data in a space for which the number of dimensions is increased by one by adding, as another component, a value that is dependent on the information, and executes clustering of the constructed point group data. In other words, the information processing apparatus 10 is able to construct a feature value from the given point group data and execute clustering in combination with coordinate components.

As a result, when performing fitting of a mesh shape (polygon) to point group data that is scanned in a three-dimensional space, the information processing apparatus 10 is able to extract a set of singular points, such as corners, for example. At this time, the information processing apparatus 10 is able to separately execute clustering of points that have singular points. In this manner, the information processing apparatus 10 is able to extract a portion that is particularly sharp or a portion in a different dimension, so that even if an entire shape of point group data is not known in advance, it is possible to execute clustering of the point group data by taking into account a geometrical feature of the point group data and it is possible to accurately perform fitting.

### [c] Third Embodiment

While the embodiments of the present invention have been described above, the present invention may be embodied in various forms other than the above-described embodiments.

Values etc.

Exemplary values, matrices, the number of dimensions, various variables, and the like used in the embodiments as described above are merely examples and may be arbitrarily changed. Further, the flow of the process described in each of the flowcharts may be appropriately changed as long as not contradiction is derived. Furthermore, as a clustering method, various clustering method, such as the K-average method or the mean shift method, may be used.

System

The processing procedures, control procedures, specific names, and information including various kinds of data and parameters illustrated in the above-described document and drawings may be arbitrarily changed unless otherwise specified.

Further, the illustrated respective components of the respective devices are of functional concept, and it is not always configured physically as illustrated. In other words, specific forms of distribution and integration of the apparatuses are not limited to those illustrated in the drawings. That is, all or part of the apparatuses may be functionally or physically distributed or integrated in arbitrary units depending on various loads or use conditions.

Furthermore, for each processing function performed by each apparatus, all or any part of the processing function may be implemented by a central processing unit (CPU) and a program analyzed and executed by the CPU or may be implemented as hardware by wired logic.

Hardware

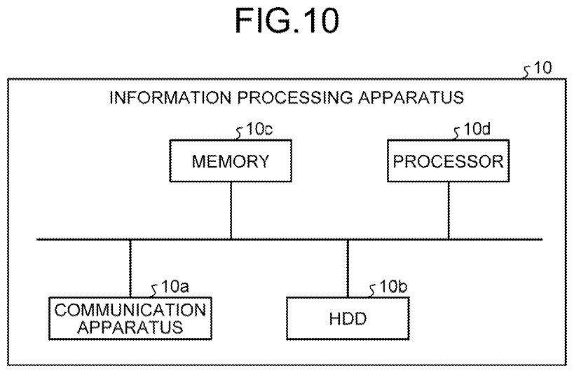

FIG. 10 is a diagram for explaining a hardware configuration example. As illustrated in FIG. 10, the information processing apparatus 10 includes a communication apparatus 10a, a hard disk drive (HDD) 10b, a memory 10c, and a processor 10d. All of the units illustrated in FIG. 10 are connected to one another via a bus or the like.

The communication apparatus 10a is a network interface card or the like and performs communication with other apparatuses. The HDD 10b stores therein a program or a DB for implementing the functions illustrated in FIG. 10.

The processor 10d reads a program that performs the same process as each of the processing units illustrated in FIG. 10 from the HDD 10b or the like, loads the program onto the memory 10c, and operates a process for implementing each of the functions described in FIG. 10 or the like. For example, the process executes the same function as that of each of the processing units included in the information processing apparatus 10. Specifically, the processor 10d reads a program that has the same functions as those of the vector calculation unit 21, the curvature calculation unit 22, the feature generation unit 23, and the like from the HDD 10b or the like. Then, the processor 10d performs the process that executes the same processing as those of the vector calculation unit 21, the curvature calculation unit 22, the feature generation unit 23, and the like.

As described above, by reading and executing the program, the information processing apparatus 10 functions as an information processing apparatus that implements a feature value calculation method. Further, the information processing apparatus 10 is able to cause a medium reading apparatus to read the above-described program from a recording medium, and execute the read program to implement the same functions as those of the embodiments as described above Meanwhile, the program described herein need not always by executed by the information processing apparatus 10. For example, the present invention may be applied in the same manner to a case in which a different computer or a different server executes the program or a case in which a different computer and a different server execute the program in a cooperative manner.

The program may be distributed via a network, such as the Internet. Further, the program may be recorded in a computer-readable recording medium, such as a hard disk, a flexible disk (FD), a compact disk-read only memory (CD-ROM), a magneto-optical disk (MO), or a digital versatile disk (DVD), and may be executed by causing a computer to read the program from the recording medium.

According to one aspect, it is possible to extract an accurate feature value of point group data.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a feature value calculation program that causes a computer to execute a process, the process comprising:
calculating, for each of points included in point group data, an eigenvector by using principal component analysis on point group data that is located within a predetermined distance from each of the points;
calculating a curvature of a multivariable function in which a point located closest to the calculated eigenvector is used an extreme value point; and
generating a feature value of the point group data on the basis of the curvature at each of the points in the point group data.

2. The non-transitory computer-readable recording medium according to claim 1, wherein
the calculating includes
setting, in a space that is spanned by eigenvectors with eigenvalues equal to or later than a threshold, coordinates and an axis in directions of the eigenvectors;
generating a quadratic function that has a vertex at the extreme value point by applying a least squares method to the point group data; and
calculating Hessian with respect to the quadratic function as a curvature at each of the points in the point group data.

3. The non-transitory computer-readable recording medium according to claim 1, wherein
the generating includes generating a distribution of the curvatures of all of the points in the point group data as a feature value of the point group data.

4. A feature value calculation method comprising:
calculating, for each of points included in point group data, an eigenvector by using principal component analysis on point group data that is located within a predetermined distance from each of the points, using a processor;
calculating a curvature of a multivariable function in which a point located closest to the calculated eigenvector is used as an extreme value point, using the processor; and
generating a feature value of the point group data on the basis of the curvature at each of the points in the point group data, using the processor.

5. An information processing apparatus comprising:
a processor configured to:
calculate, for each of points included in point group data, an eigenvector by using principal component analysis on point group data that is located within a predetermined distance from each of the points;
calculate a curvature of a multivariable function in which a point located closest to the calculated eigenvector is used as an extreme value point; and
generate a feature value of the point group data on the basis of the curvature at each of the points in the point group data.
